(19) United States
(12) Patent Application Publication
(10) Pub. No.: US 2006/0147562 A1
(43) Pub. Date: Jul. 6, 2006

(54) Insect repellent based on a mixture of essential oils

(76) Inventor: Marie Sommerville, Glasgow (GB)

Correspondence Address: FLESHNER & KIM, LLP, P.O. BOX 221200, CHANTILLY, VA, 20153, US

(21) Appl. No.: 10/532,824

(22) PCT Filed: Oct. 24, 2003
(86) PCT No.: PCT/GB03/04580

§ 371 Date: Dec. 15, 2005

(30) Foreign Application Priority Data
Oct. 26, 2002 (GB) 0224992.8

(51) Int. Cl. A01N 65/00

(52) U.S. Cl. 424/736; 424/742; 424/745; 424/761; 424/769; 424/750; 424/764; 424/766

(57) ABSTRACT

A natural and non-toxic composition is described which has surprisingly superior and super additive effectiveness over conventional insect repellents. In one embodiment, the composition is comprised of a mixture of essential oils, including lime oil, myrtle, citronella oil, eucalyptus oil and neem oil in a carrier oil. Alternatively, the neem oil may be used as a carrier oil. The composition may be provided in the form of a spray or topical cream.

The present invention relates to an insect repellent. More particularly the present invention relates to a composition, which can be applied to the skin in order to repel insects including, but not limited to mosquitoes and midges.

In a number of European countries including the UK, and particularly Scotland, the midge and horsefly are serious irritants, to tourists, gardeners and sports enthusiasts, such as ramblers, hill-walkers, climbers, etc. It is estimated that around 14,000 species of midge exist, some of which carry viruses which are known to be dangerous to animals. Whilst in general, midge bites are not particularly dangerous and rarely result in disease in humans, the bites can be unpleasant and cause pruiritis (itching), eurticaria (skin eruptions) and localised inflammation. Unfortunately, it is thought that the prevalence of these pests may increase as worldwide climate changes occur.

The common midge and fly are irritating but generally harmless pests. However in many countries serious and potentially fatal diseases are spread by insects, such as mosquitoes. For example, the mosquito-borne illness, malaria, is one of the main killer diseases of the world, and causes an estimated 1 to 2 million deaths per year. In addition mosquito-borne illnesses are estimated to be transmitted to more than 700 million people annually. In some parts of Africa it is estimated that 10% of the total mortality of infants under the age of 5 is due directly to the disease. Although historically this serious illness was localised in tropical areas such as Central and South America, the Middle East, the Indian sub-continent and Asia, the prevalence of malaria is rising due to temporary migration of the population between these countries, primarily due to the increase in popularity of tropical destinations for holidays and vacations. This is exemplified in the UK, where the number of reported cases of malaria has increased dramatically in recent decades due to foreign travel. Although malaria can be cured with prescription drugs, many mosquito species have developed resistance to common anti-malarial drugs. Therefore, as with many insect borne illnesses, prophylaxis is seen as preferable to cure. This is generally achieved through a combination of vaccination and also by the prevention of bites in the first instance.

Other diseases spread by insects, include the viral illnesses Yellow Fever, Dengue Fever, Encephalitis and Filiariasis which are all mosquito-borne. For the majority of these illnesses there are no preventative vaccines, and often no specific treatment. Thus the essence of prevention is to avoid being bitten in the first place and protection from arthropod bites is paramount in ensuring a reduction in insect-borne disease. For example at present there is no effective drug treatment for Yellow Fever or Encephalitis, and therefore prophylaxis is essential. Yet further, there is no current effective vaccination for Dengue Fever, and therefore it is vitally important that the initial insect bite is avoided.

Other insect-borne diseases include leishmaniasis which is transmitted by sandflies; sleeping sickness transmitted by the tsetse fly; lyme disease and typhus fever which are transmitted by ticks.

The demand for suitable insect repellents is therefore at an all-time high. There are many well known insect repellents on the market. Historically, most include the chemical DEET (N,N diethyl-3-methylbenzamide) or DEET derivatives. The efficacy of DEET in repelling biting insects has so far not been matched by any other natural or synthetic product since being introduced in 1975. It is estimated that 38% of the American population, and over 200 million people worldwide, use DEET preparations every year. However, whilst this chemical has been proven to be highly effective in repelling insects, it is highly toxic and can be absorbed through the skin. The toxicity, due to the pharmacokinetics of the chemical, has resulted in a catalogue of reported minor to serious adverse effects in use. Heavy exposure to the chemical is known to induce memory loss, weakness, headache, fatigue, muscle and joint pain tremors and shortness of breath. Yet further, DEET can act as a skin irritant and has a disagreeable odour. In addition, care must be taken to avoid furnishings, plastic, varnished and painted surfaces, when using repellents containing this chemical. Accordingly, in recent years there has been a move towards the search for natural, non-toxic yeast effective insect repellents, which do not cause irritation or toxicity to the user.

It is an object of the present invention to provide a natural insect repellent, which is non-toxic to the user.

Yet further, it is an object of the present invention to provide a natural insect repellent, which is non-irritant and has a pleasant smell.

It is a further aim of the present invention to provide an insect repellent, which is effective against insects such as fleas, ticks, gnats and, in particular, midges and mosquitoes.

According to a first aspect of the present invention, there is provided a composition, which is effective in repelling insects, comprising a mixture of essential oils in a carrier oil.

Preferably the essential oils are lime oil, myrtle, citronella oil, eucalyptus oil and neem oil.

In a preferred embodiment, the carrier oil is grape seed oil. However, other carrier oils may be used, including almond oil, avocado oil, vegetable oil, wheat flour oil or sunflower oil, soya oil or a mixture thereof.

Preferably the carrier oil constitutes in the region of 50% of the composition.

Preferably the essential oils constitutes in the region of 50% of the composition.

Preferably the neem oil is present in a concentration of between 740 and 760 drops per 37 ml of the composition.

Most preferably the neem oil is present in a concentration of 750 drops per 37 ml of the composition.

Most preferably the myrtle is bog myrtle.

The neem oil may be in the form of an extract of the Indian Neem tree Azadirachta Indica.

Preferably the lime oil is present in a concentration of between 8 and 12 drops per ½ ml of the composition.

Most preferably the lime oil is present in a concentration of 10 drops per ½ ml of the composition.

Preferably the myrtle oil is present in a concentration of between 28 and 32 drops per 1½ ml of the composition.

Most preferably the myrtle oil is present in a concentration of 30 drops per 1½ ml of the composition.

Preferably the citronella oil is present in a concentration of between 190 and 210 drops per 10 ml of the composition.

Most preferably the citronella oil is present in a concentration of 200 drops per 10 ml of the composition.

Preferably the eucalyptus oil is present in a concentration of 3 to 7 drops per ¼ ml of the composition.

Most preferably the eucalyptus oil is present in a concentration of 5 drops per ¼ ml of the composition.

Optionally the composition is provided as a spray.

The composition is intended for topical use.

The composition is suitable for use on humans and animals.

The composition repels insects including, but not limited to midges, mosquitoes, gnats, ticks, flies and fleas.

Preferably the composition has a pleasant-odour.

According to a second aspect of the present invention, there is provided a composition, which is effective in repelling insects, comprising a mixture of lime oil, myrtle, citronella oil, eucalyptus oil and neem oil.

Most preferably the myrtle is bog myrtle.

Preferably the essential oils constitutes in the region of 50% of the composition.

Preferably the lime oil is present in a concentration of between 8 and 12 drops per ½ ml of the composition.

Most preferably the lime oil is present in a concentration of 10 drops per ½ ml of the composition.

Preferably the myrtle oil is present in a concentration of between 28 and 32 drops per 1½ ml of the composition.

Most preferably the myrtle oil is present in a concentration of 30 drops per 1½ ml of the composition.

Preferably the citronella oil is present in a concentration of between 190 and 210 drops per 10 ml of the composition.

Most preferably the citronella oil is present in a concentration of 200 drops per 10 ml of the composition.

Preferably the eucalyptus oil is present in a concentration of 3 to 7 drops per ¼ ml of the composition.

Most preferably the eucalyptus oil is present in a concentration of 5 drops per ¼ ml of the composition.

The neem oil comprises the remainder of the composition and acts as a carrier oil.

Optionally the composition is provided as a spray.

The composition is intended for topical use.

The composition repels insects including, but not limited to midges, mosquitoes, gnats, ticks, flies and fleas.

Preferably the composition has a pleasant odour.

According to the third aspect of the present invention, there is provided a composition, which is effective in repelling insects, comprising a mixture of essential oils and a base cream.

Preferably the essential oils are lime oil, myrtle, citronella oil, eucalyptus oil and neem oil.

Most preferably the myrtle is bog myrtle.

Optionally the composition comprises a carrier oil which may be grape seed oil, however other carrier oils may be used, including almond oil, avocado oil, vegetable oil, wheat flour oil or sunflower oil, soya oil or a mixture thereof.

Typically the base cream comprises a mixture of aqua, prunus dulcis, glycerine (vegetable), cetearyl alcohol, stearic acid, triethanolamine, ceteareth 20, methyl paraffin, imidazolidinyl urea and propyl paraffin.

The composition is intended for topical use.

Preferably the composition has a pleasant odour.

Advantageously, the described composition has an agreeable smell, and is completely natural and non-toxic to the user.

In the present invention, it has been discovered that the described composition has surprisingly superior and super-additive effectiveness over conventional insect repellents in repelling midges and mosquitoes. Specifically, it has been discovered that by preparing a composition comprising 10 drops per ½ ml of lime oil, 30 drops per 1½ ml of bog myrtle, 200 drops per 10 ml of citronella oil, 5 drops per ¼ ml of eucalyptus oil and 740 drops per 37 ml of neem oil, preferably with a carrier oil results in a superior non-toxic insect repellent.

It is well known in the field of aromatherapy to refer to quantities of essential oils in the form of “drops per ml”. Generally 20 drops is equivalent to 1 ml of essential oil, although the important concept is the quantity of the essential oil relative to the carrier oil, or other oils, as opposed to the exact quantity used.

In the preferred embodiment, grape seed oil is used as a carrier, however it will be appreciated that any suitable natural oil, such as almond oil, avocado oil, vegetable oil, wheat flour oil or sunflower oil, soya oil or indeed a mixture thereof could be used.

It is also appreciated that any form of eucalyptus, such as lavender eucalyptus or lemon eucalyptus could be used within the composition. Similarly, whilst the use of bog myrtle is preferred, any alternative and corresponding type of myrtle, such as white myrtle, could be used.

In an alternative embodiment, the carrier oil could be removed altogether, and the neem oil could be substituted as the carrier base.

The composition can be provided in the form of a spray or a topical cream or ointment.

The effectiveness of the composition described in the present Application has been tested in the laboratory. Comparative tests were carried out with 14 volunteers using an arm in cage technique with adult laboratory reared Aedes Aegypti (Cucilidau) insects. In this technique an area of skin (in this case the hand/arm) is coated with the composition being tested and then exposed to the insects (typically around 20 insects) within an enclosure for a set, standard period of time. The enclosures were thick plastic cylinders with a resealable opening at one end, into which a volunteers hand could be placed. All areas of the enclosure where viewable from the outside. The insects used, were chosen primarily due to their prevalence in tropical and subtropical regions. The species is a notorious insect vector. In addition this species is relatively large in size which facilitated observation regarding their movement and behavioural response to the various repellents during the tests. Effectiveness was calculated by two means, firstly by visual observation of the number of mosquitoes which land on the tester's hands, and secondly by counting of the number of visible bites which appear at the end of the test.

The volunteers were selected to representative of varying age groups and consisted of 6 males and 8 females. Repellency was calculated by measuring the landing rates of the insects. Specifically the percentage decline of mosquitoes landing within a predetermined area of skin was used as a measure of repellency efficacy. Each volunteer first undertook a control test by placing their untreated arm into the enclosure containing a mixed population of the mosquitoes. Both left and right hands were used. The volunteers wore protective gloves with a 4×6 cm square cut away, to serve as an assessment area. The assessment area could be easily viewed through the enclosure. The landing rate of the mosquitoes, and behaviour, was observed for a period of 5 minutes. Following the control test, one of the compositions being tested was applied to the exposed area of skin and allowed to dry for 10 minutes, as all products tested were aqueous solutions, and thus a period was required to allow the composition to dry on the skin. The procedure was then repeated for the treated hand.

Five commercially available repellents were compared to the composition of the present invention. Two of the five were synthetic DEET based products. The third repellent contained the active ingredient of citronella, in order to allow comparison of the repellency of the composition of the present Application with citronella. The fourth repellent was neem based, with concentrated solutions of eucalyptus, bergamot and rosemary, and allowed comparison of the repellency of the composition of the present Application with neem oil. A fifth product, a cosmetic moisturiser containing citronella was also tested.

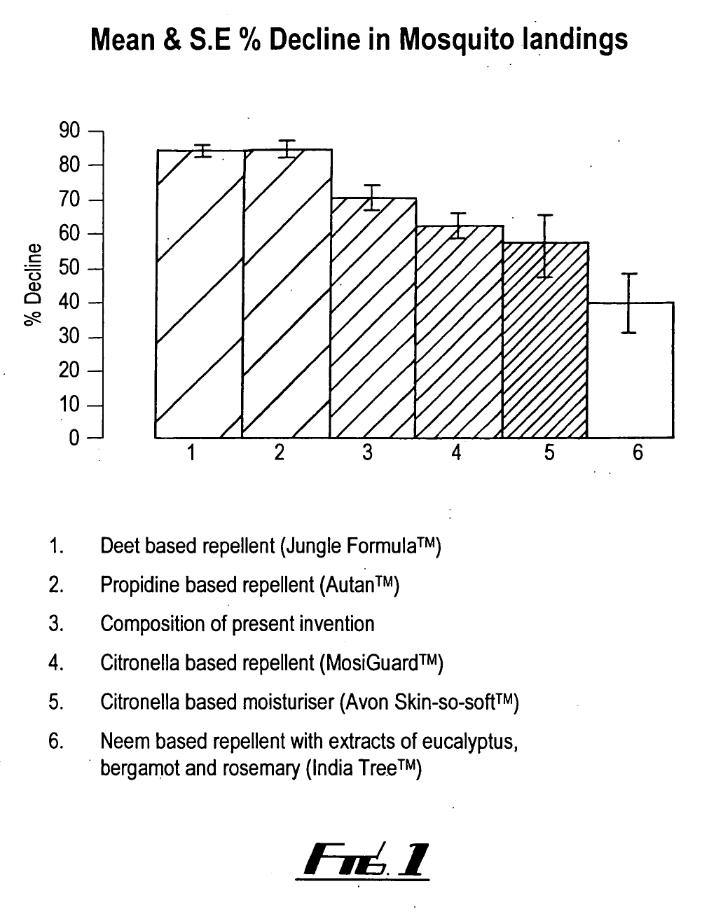

FIG. 1 illustrates the comparative efficacy of the compositions tested. Percentage repellency was calculated using:

$$100 - \frac{no of bites on treated hand \times 100}{no of bites on control hand}$$

As expected the two DEET based treatments showed the greatest repellency. However whilst these products have excellent repellency (inducing on average 84.7% and 84.6% reduction in mosquito landings) the disadvantages of these products (toxicity, high skin absorption, unpleasant smell are well documented.

The fifth repellent (neem based, with concentrated extracts of eucalyptus, bergamot and rosemary) provided the least protection from mosquito landing and in some cases failed to reduce landing rates at all. The fourth repellent, a cosmetic moisturiser reputed to have repellent properties and containing citronella, provided more protection (an average of 57.6% reduction) but was short-lived, and it is thought that the mosquitoes were temporarily repelled by the perfume component of this product. The third citronella based repellent was more effective, providing a 62% reduction in mosquito landings. However in the tests the composition of the present Application induced the closest effects to the DEET products—reducing mosquito landings by 70.6%—an additional 30% over the Neem oil based product (repellent No 5). Accordingly the composition of the present Application, which consists of a combination of essential oils, has a surprisingly synergistic effect over existing commercially available products containing these essential oils.

In addition to counting the number of landings/bites, observations of the behavioural changes in the test mosquitoes were made. This was done in order to determine where any of the compositions being tested modified or inhibited the normal mosquito behaviour.

When exposed to the DEET based repellents a dramatic change was observed in the mosquito behaviour—namely that activity levels fell greatly. Flight activity was reduced and many of the mosquitoes were observed to rest on the surface of the enclosure. In addition the mosquitoes displayed excessive cleaning, in some cases frantic cleaning of the antenna, and extensive cleaning of the proboscis, wings and appendages. This behavioural response was noticed most in male mosquitoes. These behavioural responses were not observed when the remaining three commercially available, and natural based compositions were tested, i.e. the citronella based repellent, cosmetic citronella based moisturiser, and the neem oil with extracts of eucalyptus, rosemary and bergamot) based repellent.

However, when tested, and surprisingly, the composition of the present invention elicited the same behavioural responses as the DEET products—i.e. inactivity and excessive cleaning. In addition the mosquitoes displayed irregular body movements and incoordination—many of the mosquitoes showed inability to retain grip on the enclosure walls. This was surprising as behavioural changes were not observed with the three natural based commercially available repellents. Prior to testing it was expected that behaviour of the insects when exposed to the composition of the present invention would be closer to the behaviour elicited by these other natural repellents, and not, as actually occurred in the testing, the synthetic DEET products. It has been postulated that the observed inability to co-ordinate movement is a result of highly oxidised azadirachtin molecules (the active ingredient of the neem oil in the present composition) targeting the nervous system of the insects and disrupting ganglier processes. Nevertheless these behavioural changes were not observed with the commercially available neem based product. These results suggest the composition of the present invention is substantially more effective at curtailing insect or mosquito attack than existing natural products, as it induces a lack of activity and incoordination in the mosquitoes, thus preventing biting, in a similar manner to synthetic DEET based repellents.

After exposure to the composition of the present invention, the alteration in the mosquitoes behaviour was observed to last for many hours. However after 24 hours all symptoms had disappeared, leaving no apparent lasting damage to the insects.

The composition herein described has been shown to have a substantially greater efficacy at repelling insects than existing commercially available natural oil based repellents. In particular the composition which consists of a mixture of lime oil, myrtle, citronella oil, eucalyptus oil and neem oil, has been shown to have a surprisingly greater efficacy at repelling insects than commercially available citronella or neem based repellents. The composition of the present invention, has an efficacy close to synthetic DEET products and elicits a behavioural response in mosquitoes very similar to DEET, but which is not produced by existing natural oil based repellents. Although the present composition has been shown to have a similar efficacy to DEET, it has inherent advantages over this synthetic repellent, as it has no toxic side-effects, and has a pleasant smell.

Modifications and improvements may be made to the foregoing without departing from the scope of the invention.

1. A composition, which is effective in repelling insects, comprising a mixture of essential oils in a carrier oil.

2. A composition as claimed in claim 1, wherein the essential oils are lime oil, myrtle, citronella oil, eucalyptus oil and neem oil.

3. A composition as claimed in claim 2, wherein the carrier oil is grape seed oil.

4. A composition as claimed in claim 2, wherein the carrier oil is almond oil.

5. A composition as claimed in claim 2, wherein the carrier oil is avocado oil.

6. A composition as claimed in claim 2, wherein the carrier oil is vegetable oil.

7. A composition as claimed in claim 2, wherein the carrier oil is wheat flour oil.

8. A composition as claimed in claim 2, wherein the carrier oil is sunflower oil.

9. A composition as claimed in claim 1, wherein the carrier oil constitutes 50% of the composition.

10. A composition as claimed in claim 9, wherein the essential oils constitute the remaining 50% of the composition.

11. A composition as claimed in claim 2, wherein the neem oil is present in a concentration of between 740 and 760 drops per 37 ml of the composition.

12. A composition as claimed in claim 11, wherein the neem oil is present in a concentration of 750 drops per 37 ml of the composition.

13. A composition which is effective in repelling insects, comprising a mixture of lime oil, myrtle, citronella oil, eucalyptus oil and neem oil.

14. A composition as claimed in claim 13, wherein the neem oil acts as a carrier oil.

15. A composition as claimed in claim 13, wherein the myrtle is bog myrtle.

16. A composition as claimed in claim 13, wherein the neem oil is an extract of the Indian Neem tree Azadirachta Indica.

17. A composition as claimed in claim 13, wherein the lime oil is present in a concentration of between 8 and 12 drops per ½ ml of the composition.

18. A composition as claimed in claim 17, wherein the lime oil is present in a concentration of 10 drops per ½ ml of the composition.

19. A composition as claimed in claim 13, wherein the myrtle oil is present in a concentration of between 28 and 32 drops per 1½ ml of the composition.

20. A composition as claimed in claim 19, wherein the myrtle oil is present in a concentration of 30 drops per 1½ ml of the composition.

21. A composition as claimed in claim 13, wherein the citronella oil is present in a concentration of between 190 and 210 drops per 10 ml of the composition.

22. A composition as claimed in claim 21, wherein the citronella oil is present in a concentration of 200 drops per 10 ml of the composition.

23. A composition as claimed in claim 13, wherein the eucalyptus oil is present in a concentration of 3 to 7 drops per ¼ ml of the composition.

24. A composition as claimed in claim 23, wherein the eucalyptus oil is present in a concentration of 5 drops per ¼ ml of the composition.

25. A composition as claimed in claim 13 in the form of a spray.

26. A composition which is effective in repelling insects comprising a mixture of essential oils and a base cream.

27. A composition as claimed in claim 26, wherein the essential oils are lime oil, myrtle, citronella oil, eucalyptus oil and neem oil.

28. A composition as claimed in claim 27, wherein the myrtle is bog myrtle.

29. A composition as claimed in claim 26, comprising a carrier oil.

30. A composition as claimed in claim 29, wherein the carrier oil is grape seed oil.

31. A composition as claimed in claim 29, wherein the carrier oil is almond oil.

32. A composition as claimed in claim 29, wherein the carrier oil is avocado oil.

33. A composition as claimed in claim 29, wherein the carrier oil is vegetable oil.

34. A composition as claimed in claim 29, wherein the carrier oil is wheat flour oil.

35. A composition as claimed in claim 29, wherein the carrier oil is sunflower oil.

36. A composition as claimed in claim 29, wherein the carrier oil is soya oil.

37. A composition as claimed in claim 26, wherein the base cream comprises a mixture of aqua, prunus dulcis, glycerine (vegetable), cetearyl alcohol, stearic acid, triethanolamine, ceteareth 20, methyl paraffin, imidazolidinyl urea and propyl paraffin.

38. A composition as claimed in claim 1 intended for topical use.

39. A composition as claimed in claim 1 having a pleasant odor.

40. A composition as claimed in claim 1 being suitable for repelling insects such as midges, mosquitoes, gnats, ticks, flies and fleas.

41. A composition as claimed in claim 1 suitable for use on humans.

42. A composition as claimed in claim 1 suitable for use on animals.
